(19) United States
(12) Patent Application Publication
(10) Pub. No.: US 2024/0154124 A1
(43) Pub. Date: May 9, 2024

(54) NEGATIVE ELECTRODE PLATE AND LITHIUM-ION BATTERY COMPRISING SAME

(71) Applicant: ZHUHAI COSMX BATTERY CO., LTD., Zhuhai (CN)

(72) Inventors: Weichao TANG, Zhuhai (CN); Dingguo XIA, Zhuhai (CN); Suli LI, Zhuhai (CN); Wei ZHAO, Zhuhai (CN); Junyi LI, Zhuhai (CN)

(73) Assignee: ZHUHAI COSMX BATTERY CO., LTD., Zhuhai (CN)

(21) Appl. No.: 18/398,770

(22) Filed: Dec. 28, 2023

Related U.S. Application Data
(63) Continuation of application No. PCT/CN2022/120954, filed on Sep. 23, 2022.

(30) Foreign Application Priority Data
Sep. 26, 2021 (CN) 202111132064.3

(51) Int. Cl. H01M 4/62; H01M 4/04; H01M 4/38; H01M 4/583; H01M 10/0525

(52) U.S. Cl. CPC H01M 4/622; H01M 4/0404; H01M 4/387; H01M 4/583; H01M 4/626; H01M 10/0525; H01M 2004/027

(57) ABSTRACT

Disclosed are a negative electrode plate and a lithium-ion battery including the negative electrode plate. The negative electrode plate of the present disclosure includes a current collector, a negative electrode active layer arranged on at least one functional surface of the current collector, and a lithium source; and the negative electrode active layer includes a negative electrode active material and a polymer, the polymer includes a first structural unit, the first structural unit is selected from an olefin compound containing a substituted or unsubstituted ureido group, and the olefin compound includes at least one cyclic group. The negative electrode plate of the present disclosure can effectively supplement a lithium loss of the lithium-ion battery in an application process, so that initial charge/discharge efficiency and cycling performance of the lithium-ion battery are improved.

### CROSS-REFERENCE TO RELATED APPLICATIONS

The present disclosure is a continuation of International Application No. PCT/CN2022/120954, filed on Sep. 23, 2022, which claims priority to Chinese Patent Application No. 202111132064.3, filed on Sep. 26, 2021. The disclosures of the aforementioned applications are hereby incorporated by reference in their entireties.

### TECHNICAL FIELD

The present disclosure pertains to the field of lithium-ion batteries, and specifically relates to a negative electrode plate and a lithium-ion battery including the negative electrode plate.

### BACKGROUND

Lithium-ion batteries have the advantages of long cycle life and environmental friendliness, and are widely used in portable electronic products such as mobile phones and laptop computers and new energy vehicles. The development of new energy vehicles can effectively alleviate energy and environmental problems, while power batteries are the key factor to solving the “mileage anxiety” of pure electric vehicles, so that the research on the power batteries with high energy density and long cycle life by improving the first charging and discharging efficiency of the lithium-ion batteries is a crucial link in the field of new energy vehicles.

In view of this situation, at present, a lithium supplementation method is often used to solve the above problems, so as to improve the first charging and discharging efficiency of the lithium-ion batteries, and increase the energy density and cycle life of the batteries. Previously reported lithium supplementation methods may be roughly divided into positive electrode lithium supplementation and negative electrode lithium supplementation. For the negative electrode lithium supplementation, an elemental lithium source is mainly used to supplement lithium to a negative electrode by electrochemical lithium pre-intercalation, internal short circuit, external short circuit, and other methods. However, all effects of negative electrode lithium supplementation at present are not ideal, and the initial charge/discharge efficiency and cycling performance of the prepared batteries are poor.

### SUMMARY

The present disclosure provides a negative electrode plate, which can effectively supplement lithium in a use process of a lithium-ion battery by limiting a composition and a structure of the negative electrode plate.

The present disclosure further provides a lithium-ion battery, which includes the negative electrode plate above, and the lithium-ion battery has the advantages of high initial charge/discharge efficiency and excellent cycling performance.

The present disclosure provides a negative electrode plate, which includes a current collector, a negative electrode active layer arranged on at least one functional surface of the current collector, and a lithium source;

the negative electrode active layer includes a negative electrode active material and a polymer, the polymer includes a first structural unit, the first structural unit is selected from an olefin compound containing a substituted or unsubstituted ureido group, and the olefin compound containing the substituted or unsubstituted ureido group includes at least one cyclic group.

According to the negative electrode plate above, the olefin compound containing the substituted or unsubstituted ureido group has a structure shown in Formula 1:

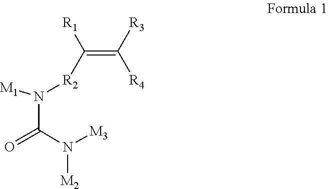

where, R₁, R₃ and R₄ are each independently selected from H, halogen, nitro, cyano, substituted or unsubstituted C₁₋₁₂ alkyl, substituted or unsubstituted C₁₋₁₂ alkoxy, and substituted or unsubstituted amino; R₂ is selected from carbonyl, substituted or unsubstituted (hetero)aryl, ester, substituted or unsubstituted C₁₋₁₂ alkylene, carboxyl, or a chemical bond; M₁ is selected from H, carbonyl, substituted or unsubstituted C₁₋₂₀ alkyl, substituted or unsubstituted C₁₋₂₀ alkoxy, hydroxyl, halogen, amino, nitro, trifluoromethyl, sulfenyl, and substituted or unsubstituted (hetero)aryl; M₂ and M₃ are each independently selected from hydrogen, substituted or unsubstituted C₄₋₆₀ (hetero)aryl, substituted or unsubstituted C₁₋₂₀ alkyl, substituted or unsubstituted C₁₋₂₀ alkoxy, carbonyl, substituted or unsubstituted C₂₋₁₂ cycloalkyl containing heterocyclic atom, acyl, carboxyl, ester, or M₂ and M₃ bonded to form a ring; and R₁-R₄ and M₁-M₃ include at least one cyclic group.

According to the negative electrode plate above, the lithium source is distributed on a surface and/or in an interior of the negative electrode active layer.

According to the negative electrode plate above, the lithium source is selected from a lithium powder or a lithium foil.

According to the negative electrode plate above, the negative electrode active material includes hard carbon, a tin-based material and a lithium carbon material.

According to the negative electrode plate above, a number-average molecular weight of the polymer ranges from 4,000 to 90,000, and a mass proportion of the first structural unit in the polymer is no less than 30%.

According to the negative electrode plate above, the olefin compound containing the substituted or unsubstituted ureido group is prepared by a method including the following process of:

reacting a solvent system containing a first isocyanate compound and a first amine compound or a solvent system containing a second isocyanate compound and a second amine compound to obtain the olefin compound containing the substituted or unsubstituted ureido group, where the first isocyanate compound meets a structure shown in Formula 2a, the first amine compound meets a structure shown in Formula 3a, and the first amine compound is a primary amine or secondary amine compound; and the second amine compound meets a structure shown in Formula 2b, the second isocyanate compound meets a structure shown in Formula 3b, and in Formula 3b, Mₓ is M₂ or M₃,

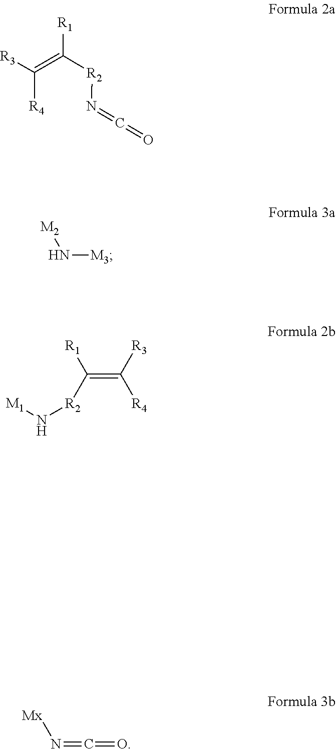

According to the negative electrode plate above, the negative electrode active layer includes 90%-99% of negative electrode active material, 0.001%-1% of polymer, 0.499%-4% of binder, and 0.5%-5% of conductive agent in terms of mass percentage.

According to the negative electrode plate above, a mass ratio of the lithium source to the polymer is 1:(1-1,000).

The present disclosure further provides a lithium-ion battery including the negative electrode plate above.

According to the negative electrode plate of the present disclosure, the polymer including the olefin structural unit containing the substituted or unsubstituted ureido group can effectively assist the lithium source to supplement lithium to the negative electrode plate, so that the lithium-ion battery has high initial charge/discharge efficiency and excellent cycling performance.

The lithium-ion battery of the present disclosure includes the negative electrode plate above, so that the lithium-ion battery has high initial charge/discharge efficiency and excellent cycling performance.

### DETAILED DESCRIPTION OF THE EMBODIMENTS

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

A first aspect of the present disclosure provides a negative electrode plate, which includes a current collector, a negative electrode active layer arranged on at least one functional surface of the current collector, and a lithium source; where the negative electrode active layer includes a negative electrode active material and a polymer, the polymer includes a first structural unit, the first structural unit is selected from an olefin compound containing a substituted or unsubstituted ureido group, and the olefin compound containing the substituted or unsubstituted ureido group includes at least one cyclic group.

The polymer in the negative electrode plate of the present disclosure includes a substituted or unsubstituted ureido group, where a structure of the ureido group unsubstituted by a substituent is as follows:

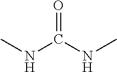

The substituted ureido group refers to that one hydrogen in the ureido group is substituted by a substituent R or two hydrogens are both substituted by the substituent R, and a structural formula is as follows:

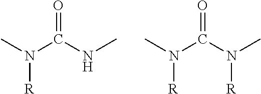

The substituent of the ureido group is not limited in the present disclosure, for example, R may be acyl, carboxyl, substituted or unsubstituted C₁-C₃₆ alkyl, substituted or unsubstituted C₆-C₃₀ aryl, substituted or unsubstituted C₃-C₃₀ heteroaryl, substituted or unsubstituted alkoxy, and the like. When these groups have substituents, the substituents are each independently selected from one or more of halogen, cyano, nitro, amino, C₁-C₁₀ alkyl, C₂-C₆ alkenyl, C₁-C₆ alkoxy or thioalkoxy, C₆-C₃₀ aryl, C₃-C₃₀ heteroaryl, and the like.

Specifically, the above polymer comes from polymerization between monomers, and a specific form of polymerization is not limited in the present disclosure. For example, the above polymer may be obtained by homopolymerizing one monomer or copolymerizing two or more different monomers. However, it is necessary to satisfy that one of monomers participating in the polymerization of the polymer in the present disclosure is the olefin compound containing the substituted or unsubstituted ureido group. Certainly, when two or more monomers participate in the polymerization, a number of the olefin compounds containing the substituted or unsubstituted ureido group as the monomers are not limited in the present disclosure. All monomers participating in the polymerization may be the olefin compounds containing the substituted or unsubstituted ureido group, or some monomers may be the olefin compounds containing the substituted or unsubstituted ureido group.

In addition, the polymer may be mixed with other substances (such as a negative electrode active material, a binder, a conductive agent, and the like) in the negative electrode active layer to form the negative electrode active layer, or the polymer is coated on a part of a surface of the negative electrode active material as a shell layer material to form a core-shell material, and then mixed with a conductive agent, a binder, and the like to form the negative electrode active layer, or there may be the above two situations at the same time.

It is found from the research of the applicant that, when the negative electrode plate includes the above polymer and the lithium source, the negative electrode plate can obtain a good lithium supplementation effect, which may be because: some low-potential active sites may appear on the negative electrode plate subjected to lithium supplementation by the lithium source, and the branched ureido polymer may adhere to surfaces of the active sites, so as to wrap the low-potential active sites and form a relatively stable interface film on the surfaces, thus improving an initial charge/discharge efficiency and cycling performance of the battery subjected to lithium supplementation.

In a specific embodiment, the olefin compound containing the substituted or unsubstituted ureido group has a structure shown in Formula 1:

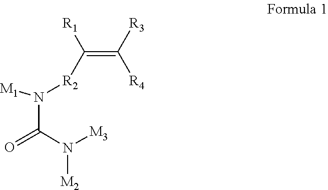

where, R₁, R₃ and R₄ are each independently selected from H, halogen, nitro, cyano, substituted or unsubstituted C₁₋₁₂ alkyl, substituted or unsubstituted C₁₋₁₂ alkoxy, and substituted or unsubstituted amino; R₂ is selected from carbonyl, substituted or unsubstituted (hetero)aryl, ester, substituted or unsubstituted C₁₋₁₂ alkylene, carboxyl, or a chemical bond; M₁ is selected from H, carbonyl, substituted or unsubstituted C₁₋₂₀ alkyl, substituted or unsubstituted C₁₋₂₀ alkoxy, hydroxyl, halogen, amino, nitro, trifluoromethyl, sulfenyl, and substituted or unsubstituted (hetero)aryl; M₂ and M₃ are each independently selected from hydrogen, substituted or unsubstituted C₄₋₆₀ (hetero)aryl, substituted or unsubstituted C₁₋₂₀ alkyl, substituted or unsubstituted C₁₋₂₀ alkoxy, carbonyl, substituted or unsubstituted C₂₋₁₂ cycloalkyl containing heterocyclic atom, acyl, carboxyl, ester, or M₂ and M₃ bonded to form a ring; and R₁R₄ and M₁-M₃ include at least one cyclic group.

Specifically, when R₁, R₃ and R₄ have a substituent, the substituent may be selected from halogen, nitro, cyano, hydroxyl, trifluoromethyl, C₁₋₁₂ sulfenyl, and the like.

R₂ is carbonyl RCO—* (R is substituted or unsubstituted C₁₋₁₂ liner alkyl, substituted or unsubstituted C₃₋₁₂ cycloalkyl, substituted or unsubstituted C₁₋₁₂ alkoxy, substituted or unsubstituted C₄₋₆₀ (hetero)aryl, and substituted or unsubstituted hydroxyl, and the substituent is C₄₋₆₀ (hetero)aryl, halogen, nitro, amino, cyano, and the like), substituted or unsubstituted (hetero)aryl (a carbon atom (or hetero atom) on the (hetero)aryl is in direct bonding connection with an N atom in the ureido, or a substituent on the (hetero)aryl is in direct bonding connection with the N atom in the ureido, and the substituent is C₁₋₁₂ alkyl, C₁₋₁₂ alkoxy, nitro, halogen, amino, carboxyl, ester, acyl, and the like), ester —COOR—* (R is substituted or unsubstituted C₁₋₁₂ liner alkyl and substituted or unsubstituted C₃₋₁₂ cycloalkyl, and the substituent is cyano, nitro, amino, halogen, and the like), a chemical bond (a double-bonded carbon atom is in direct bonding connection with a nitrogen atom in the ureido), substituted or unsubstituted C₁₋₁₂ alkylene (the substituent is cyano, nitro, amino, halogen, and the like), and carboxyl RCOOH (R is substituted or unsubstituted C₁₋₁₂ alkyl or alkenyl and is in direct bonding connection with the N atom in the ureido and the double-bonded carbon atom at the same time, and the substituent is C₁₋₁₂ alkoxy, halogen, cyano, nitro, amino, halogen, and the like), where, “-*” represents a chemical bond in direct bonding connection with the N atom in the ureido, and “-” represents a chemical bond in direct bonding connection with the double-bonded carbon atom.

M₁ is selected from H, substituted or unsubstituted C₁₋₂₀ alkyl (the substituent is C₁₋₁₂ alkoxy, C₄₋₃₀ (hetero)aryl, halogen, amino, carboxyl, ester, acyl, and the like), substituted or unsubstituted C₁₋₂₀ alkoxy (the substituent is C₁₋₁₂ alkyl, C₄₋₃₀ (hetero)aryl, nitro, halogen, amino, carboxyl, ester, acyl, and the like), hydroxyl, halogen, amino, nitro, trifluoromethyl, sulfenyl, substituted or unsubstituted (hetero)aryl (with a definition the same as that in R₂), and carbonyl RCO—* (with a definition the same as that in R₂), where, “-*” represents a chemical bond in direct bonding connection with the N atom in the ureido.

M₂ and M₃ are respectively independently selected from hydrogen, substituted or unsubstituted C₄₋₆₀ (hetero)aryl (with a definition the same as that in R₂), substituted or unsubstituted C₁₋₂₀ alkyl (with a definition the same as that in M₁), substituted or unsubstituted C₁₋₂₀ alkoxy (with a definition the same as that in M₁), carbonyl RCO—* (with a definition the same as that in M₁), substituted or unsubstituted C₂₋₁₂ cycloalkyl containing a heterocyclic atom (the substituent is C₁₋₁₂ alkoxy, C₄₋₃₀ (hetero)aryl, halogen, amino, carboxyl, ester, acyl, and the like), acyl RCO—* (R is substituted or unsubstituted C₁₋₁₂ alkyl or alkenyl, halogen, amino, and the like, and the substituent is C₁₋₁₂ alkoxy, halogen, cyano, nitro, amino, and the like), carboxyl RCOOH (R is substituted or unsubstituted C₁₋₁₂ alkyl or alkenyl and is in direct bonding connection the N atom in the ureido, and the substituent is C₁₋₁₂ alkoxy, halogen, cyano, nitro, amino, halogen, and the like), ester RCOOR—* (R is substituted or unsubstituted C₁₋₁₂ alkyl or alkenyl, and the substituent is C₁₋₁₂ alkoxy, halogen, cyano, nitro, amino, halogen, and the like), ester *—RCOOR— (R is substituted or unsubstituted C₁₋₁₂ alkyl or alkenyl, and the substituent is C₁₋₁₂ alkoxy, halogen, cyano, nitro, amino, halogen, and the like), or the M₂ and M₃ bonded to form a ring (such as substituted or unsubstituted C₄₋₃₀ cycloalkyl, substituted or unsubstituted C₄₋₃₀ cycloalkenyl, substituted or unsubstituted C₄₋₃₀ aryl, and the like, and further, a ring-forming atom further includes a hetero atom, and the substituent is C₁₋₁₂ alkyl, C₁₋₁₂ alkoxy, nitro, halogen, trifluoromethyl, amino, hydroxyl, methylthio, carboxyl, ester, acyl, carbonyl, and the like), where, “*-” and “-*” both represent a chemical bond in direct bonding connection with the N atom in the ureido.

Further, a molecular weight of the olefin compound containing the substituted or unsubstituted ureido group ranges from 100 to 5,000. The above molecular weight within a appropriate range can avoid the phenomenon of easy volatilization of the olefin compound during processing at a low boiling point caused by an excessively low molecular weight, and can also avoid the phenomenon of incapability of preparing a sample with a stable performance under high polymerization difficulty caused by an excessively high molecular weight. The molecular weight of the olefin compound containing the substituted or unsubstituted ureido group further preferably ranges from 300 to 1,500.

A distribution form of the lithium source in the negative electrode plate is not limited in the present disclosure. The lithium source may be distributed on a surface or in an interior of the negative electrode active layer, and may also be distributed on both the surface and in the interior of the negative electrode active layer.

In a specific embodiment, the lithium source may be selected from lithium powder or a lithium foil. It may be understood that, when the lithium source is lithium powder, the lithium powder may be mixed with the negative electrode active material and the polymer to prepare the negative electrode active layer, and at the moment, the lithium source is mainly distributed in the interior of the negative electrode active layer and a few of lithium source is inevitably distributed on the surface of the negative electrode active layer; and when the lithium source is lithium foil, the lithium foil is generally arranged on the surface of the negative electrode active layer far away from the current collector.

It is found from the research of the applicant that, when an initial charge/discharge efficiency of the negative electrode active material is low, the negative electrode plate needs to be supplemented with lithium to achieve a better effect. Specifically, the negative electrode active material is selected from at least one of hard carbon, a tin-based material, or a lithium carbon material.

In a specific embodiment, a number-average molecular weight of the polymer ranges from 4,000 to 90,000, and a mass proportion of the first structural unit in the polymer is no less than 30%. When the polymer has the above number-average molecular weight and the first structural unit has the above mass proportion in the polymer, the polymer can better assist with the negative electrode active material and the lithium source to supplement lithium to the negative electrode plate.

The applicant also found that a crystallinity of the polymer also plays a certain role in improving a lithium supplementation effect on the negative electrode plate. When the degree of crystallinity is less than or equal to 35%, an interface contact performance between a positive electrode plate and a solid electrolyte is better. Specifically, the degree of crystallinity of the polymer may be controlled by controlling a type of a monomer added, a quality of the monomer, a type of an initiator, a temperature and time, so as to meet the above requirements for the crystallinity.

In the present disclosure, a method for detecting the degree of crystallinity specifically includes: testing the degree of crystallinity of the polymer by an X-ray diffraction technology, and separating crystalline scattering from amorphous scattering on a diffraction diagram based on the fact that an X-ray scattering intensity is in direct proportion to a mass of a scattering substance, and the degree of crystallinity Xc=A/(A+B), where A is a crystalline scattering intensity and B is an amorphous scattering intensity.

In a specific embodiment, the olefin compound containing the substituted or unsubstituted ureido group may be obtained by a preparation method including the following process of:

reacting a solvent system containing a first isocyanate compound and a first amine compound (primary amine or secondary amine) to obtain the olefin compound containing the substituted or unsubstituted ureido group, i.e., the compound shown in Formula 1. The first isocyanate compound meets a structure shown in Formula 2a, and the first amine compound meets a structure shown in Formula 3a. The groups in the structures shown in Formula 2a and Formula 3a may be referred to the above.

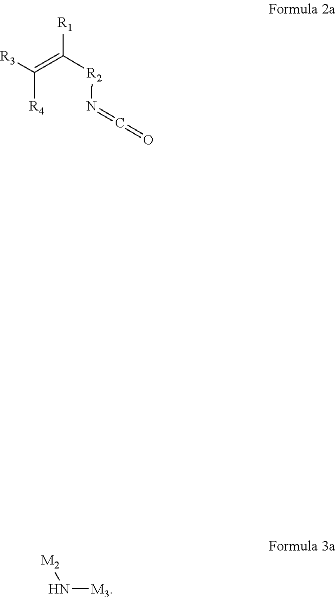

In the compound shown in Formula 1 prepared by the preparation method, M₁ is a hydrogen atom.

The first isocyanate compound meeting Formula 2a may be selected from, for example, at least one of propenyl isocyanate, acrylic isocyanate, and acryloyl isocyanate, or derivatives thereof. Specifically, the first isocyanate compound is selected from at least one of methacryloyl isocyanate, 3 -isopropenyl-α,α-dimethylbenzyl isocyanate, 2-isocyanatoethyl acrylate, isocyanatoethyl methacrylate, vinyl isocyanate, 3-propylene isocyanate, or 3-ethoxy-2-acryloyl isocyanate.

The first amine compound meeting Formula 3a may be selected from, for example, at least one of 2-aminopyrimidine-5-carboxylic acid, 2-amino-3-iodo-5-methylpyridine, N-(4-pyridinemethyl)ethylamine, 3-methylthiophene-2-carboxamide, 2-bromo-3-amino-4-methylpyridine, 6-azauracil, 3-chloro-4-fluorobenzylamine, 2-amino-5,7-difluorobenzothiazole, 3,4-pyridinediimide, morpholine, 2,4-dichloroaniline, 3-aminophthalic anhydride, 2-amino-3-hydroxymethylpyridine, 3-amino-4-chloropyridine, triphenylmethylamine, 1,3-benzothiazole-5 -amine, 2-amino-5-cyanopyridine, 4-aminoisoxazole, 2-amino-isonicotinic acid ethyl ester, 2,2′-dipicolylamine, 1,2-dimethyl piperazine, L-prolinamide, propylthiouracil, 5-fluoro-2-(3H)-benzothiazolone, 5-bromopyrimidine-4-one, N-acetyl-D-alanine, (S)-4-isopropyl-2-oxazolidinone, 1-(2-piperazine-1-ylacetyl)pyrrolidine, 2 -methyl-4 -acetylaminopyridine, 2-chloromethyl-6-methyl-thieno[2,3-D]pyrimidine-4-(3H)- one, 2-hydroxy-4-cmethylpyridine, trithiocyanuric acid, 2 -methylthio-4, 6-dihydroxypyrimidine, 4-hydroxy-6-trifluoromethylpyrimidine, (1,4,7,10-tetraaza-cyclododec-1-yl)-allyl acetate, (S)-(-)-2-amino-4-pentenoic acid, Fmoc-L-allylglycine, Fmoc-D-allylglycine, DL-2-amino-4-pentenoic acid, or D-2-amino-4-bromopentenoic acid.

In another embodiment, the compound shown in Formula 1 may further be prepared by a method including the following process of:

reacting a solvent system containing a second isocyanate compound and a second amine compound to obtain the olefin compound containing the substituted or unsubstituted ureido group; where the second amine compound meets a structure shown in Formula 2b, and the second isocyanate compound meets a structure shown in Formula 3b, and in Formula 3b, Mₓ is M₂ or M₃. The groups in the structures shown in Formula 2b and Formula 3b may be referred to the above descriptions.

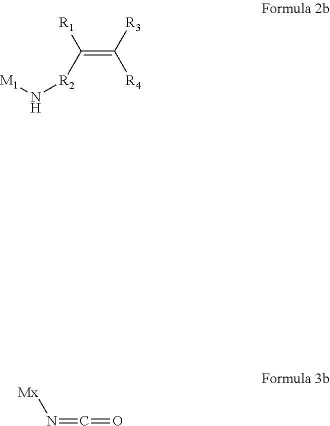

In the compound shown in Formula 1 prepared by the preparation method, M₂ or M₃ is a hydrogen atom.

The second amine compound meeting Formula 2b may be selected from, for example, at least one of a pentenoic acid olefin compound containing a primary amine or secondary amine group, a glycine olefin compound containing a primary amine or secondary amine group, or a carboxylic acid ester olefin compound containing a primary amine or secondary amine group. Specifically, the second amine compound is selected from at least one of (1,4,7,10-tetraaza-cyclododec-1-yl)-allyl acetate, (S)-(-)-2-amino-4-pentenoic acid, Fmoc-L-allylglycine, Fmoc-D-allylglycine, DL-2-amino-4-pentenoic acid, or D-2-amino-4-bromopentenoic acid.

The second isocyanate compound meeting Formula 3b may be selected from, for example, at least one of p-methoxyphenyl isocyanate, 3,4-dichlorophenyl isocyanate, 4-methoxybenzyl isocyanate, 2-phenethyl isocyanate, 4-bromo-3-methylphenyl isocyanate, 2-(methoxycarbonyl)phenyl isocyanate, 4-bromo-2-chlorophenyl isocyanate, 2,3,5-dimethylphenyl isocyanate, 2-methoxy-4-nitrobenzene isocyanate, 4-chloro-3-nitrobenzene isocyanate, 2-chloro-5-(trifluoromethyl)phenyl isocyanate, 2,5-difluorophenyl isocyanate, 4-cyanophenyl isocyanate, 6-fluoro-1H-1,3-benzodioxin(hetero)-8-yl isocyanate, 4-isocyano-3-methyl-5-phenyl isoxazole, α-methylbenzyl isocyanate, 2-methyl-3-nitrophenyl isocyanate, 4-trifluoromethyl thiophenyl isocyanate, 2-nitrophenol isobutyrate, methyl 4-isocyanatobenzoate, benzyl 4-isothiocyantetrahydroxy-1-(2H)-pyridylcarboxylate, 2-thiophene isocyanate, 3-chloro-4-methoxyphenyl isocyanate, 2,3 -dihydro-1-benzofuran-5-yl isocyanate, 2-fluoro-4-isocyanate-1-methoxybenzene, methyl 3-isocyanatothiophene-2-carboxylate, 3-bromophenyl isocyanate, or 4-(methylthio)phenyl isocyanate.

In the above two preparation embodiments, the reaction system further includes a solvent in addition to the isocyanate compounds and the amine compounds. The reaction solvent may be at least one of water, N-methylpyrrolidone (NMP), acetonitrile, hydrofluoroether, acetone, tetrahydrofuran, dichloromethane, pyridine, dimethylbenzene, or toluene.

In the process of reaction, in order to make the reaction fully and avoid the formation of other impurities, a molar ratio of the isocyanate compounds to the amine compounds may be controlled to 1:1.

It may be understood that in order to accelerate a preparation efficiency of the compound shown in Formula 1, two raw materials can be fully mixed by controlling a stirring speed before the reaction. The mixing may be carried out at a speed of 200-2,000 r/min, a mixing time may be controlled at 30-400 minutes, and the mixing may be carried out in an inert atmosphere.

In a specific embodiment, the isocyanate compounds and the amine compounds may be reacted at 30-60° C. for 2-30 hours.

As mentioned above, the polymer in the positive electrode plate of the present disclosure may further include other structural units without a substituted or unsubstituted urea group in addition to the first structural unit containing the substituted or unsubstituted urea group, and such structural units without a substituted or unsubstituted urea group are referred to as second structural units in the present disclosure. The second structural unit is derived from an olefin compound having an olefinic bond capable of participating in polymerization, and more specifically, from an olefin compound without a substituted or unsubstituted ureido group. It should be noted that the second structural unit mentioned in the present disclosure refers to a unit that does not contain a substituted or unsubstituted urea group, so the polymer may contain a plurality of different second structural units. For example, the olefin compound without the substituted or unsubstituted ureido group may be selected from at least one of acrylic acid, acrylate, polyethylene glycol methacrylate, methyl methacrylate, acrylonitrile, amino acrylate, trimethylolpropane trimethacrylate, or a vinyl silicon material.

In a specific embodiment, a mass ratio of the lithium source to the polymer is 1:(1-1000) in order to enable the polymer to better assist the lithium source to replenish lithium to the negative electrode plate.

In a specific embodiment, the negative electrode active layer includes 90%-99% of negative electrode active material, 0.001%-1% of polymer, 0.499%-4% of binder, and 0.5%-5% of conductive agent in terms of mass percentage.

Types of the conductive agent are not particularly limited in the present disclosure, and all conductive agents commonly used in this field may be selected, including but not limited to at least one of conductive carbon black, ketjen black, conductive fiber, conductive polymer, acetylene black, carbon nanotubes, graphene, flake graphite, conductive oxide, or metal particles.

Types of the binder are not particularly limited in the present disclosure, and all binders commonly used in this field may be selected, including but not limited to at least one of polyvinylidene fluoride and a copolymer derivative thereof, polytetrafluoroethylene and a copolymer derivative thereof, polyacrylic acid and a copolymer derivative thereof, polyvinyl alcohol and a copolymer derivative thereof, polymerized styrene-butadiene rubber and a copolymer derivative thereof, polyimide and a copolymer derivative thereof, polyethyleneimine and a copolymer derivative thereof, polyacrylate and a copolymer derivative thereof, or sodium carboxymethyl cellulose and a copolymer derivative thereof.

In order to make a solid-state battery have both safety performance and energy density, a thickness of the current collector in the negative electrode plate ranges from 2 μm to 20 μm, and a thickness of the negative electrode active layer ranges from 3 μm to 120 μm.

The present disclosure does not limit the preparation method of the negative electrode plate, and in an alternative embodiment, the negative electrode plate may be prepared by the following method:

mixing a polymer monomer and an initiator to initiate a polymerization reaction to obtain a polymer; and mixing the polymer, a negative electrode active material, a lithium powder, a conductive agent and a binder in a solvent to obtain a negative electrode active slurry, applying the negative electrode active slurry on a negative electrode current collector, followed by drying and cutting, to obtain the negative electrode plate.

In another alternative embodiment, the negative electrode plate may be prepared by the following method:

mixing a polymer monomer, an initiator, a negative electrode active material, a lithium powder, a conductive agent and a binder in a solvent to obtain a negative electrode active slurry, applying the negative electrode active slurry on a negative electrode current collector, initiating a polymerization reaction at 80° C., polymerizing for 6 hours, drying and cutting to obtain the negative electrode plate.

In another alternative embodiment, the negative electrode plate may be prepared by the following method:

mixing a polymer monomer and an initiator to initiate a polymerization reaction to obtain a polymer; and mixing a polymer monomer, a negative electrode active material, a conductive agent and a binder in a solvent to obtain a negative electrode active slurry, applying the negative electrode active slurry on a negative electrode current collector, and drying to obtain a negative electrode active layer, rolling a layer of lithium foil on the negative electrode active layer, and then cutting to obtain the negative electrode plate.

In yet another alternative embodiment, the negative electrode plate may be prepared by the following method:

mixing a polymer monomer, an initiator, a negative electrode active material, a conductive agent and a binder in a solvent to obtain a negative electrode active slurry, applying the negative electrode active slurry on a negative electrode current collector, initiating a polymerization reaction and then drying to obtain a negative electrode active layer, rolling a layer of lithium foil on the negative electrode active layer, and then cutting to obtain the negative electrode plate.

A second aspect of the present disclosure provides a lithium-ion battery, where the lithium-ion battery includes the negative electrode plate provided in the first aspect of the present disclosure.

A specific form of the lithium-ion battery is not limited in the present disclosure, for example, the lithium-ion battery may be a solid-state battery, a liquid-state battery, a semi-solid-state battery, a quasi-solid-state battery, a gel-state battery, and the like.

The present disclosure will be further described in detail below with reference to the specific embodiments.

The experimental methods used in the following embodiments are conventional unless otherwise specified. The reagents, materials and the like, used in the following embodiments are commercially available unless otherwise specified.

### Example 1

A preparation method of a lithium-ion battery in this example included the following steps.

### (1) Preparation of a Negative Electrode Plate

S1: 2-isocyanatoethyl acrylate and 2-hydroxy-4-cmethylpyridine were added into 100 g of p-xylene in an inert atmosphere, and stirred at 50° C. for 200 minutes at a rotating speed of 400 r/min, and then the solvents were removed to obtain a first monomer.

S2: the first monomer, poly(ethylene glycol) methyl ether acrylate (second monomer) and Azobisisobutyronitrile AIBN (initiator) were mixed in an inert atmosphere, and a polymerization reaction was initiated at 80° C. for 3 hours to obtain a polymer.

S3: 1 g of polymer, 90.98 g of hard carbon, 0.02 g of lithium powder, 4 g of conductive carbon black and 4 g of polyvinylidene fluoride PVDF were added into 100 g of p-xylene in an inert atmosphere, stirred at 500 r/min for 6 hours, and then evenly mixed to obtain a negative electrode active slurry, the negative electrode active slurry was coated on a copper foil, dried and cut to obtain the negative electrode plate.

### (2) Preparation of a Positive Electrode Plate

97 g of nickel cobalt manganese ternary material (Li[Ni_{0.6}Co_{0.2}Mn_{0.2}]O₂), 2 g of conductive carbon black, 1 g of polyvinylidene fluoride (dissolved in 100 g of NMP) and 50 g of NMP were evenly mixed and coated on a surface of an aluminum foil current collector, followed by drying, rolling and cutting, to obtain the positive electrode plate.

### (3) Assembly

The positive electrode plate, a separator and the negative electrode plate obtained above were laminated to obtain a lithium-ion battery cell, injected with an electrolyte solution (SEVEN CZWL21), packaged and formed to obtain the lithium-ion battery.

### Examples 2-6

The preparation methods in Examples 2-6 were basically the same as those in Example 1. The main differences were types of the first monomer, the second monomer, the initiator and the negative electrode active material as well as the preparation parameters of the polymer. The specific differences are listed in Tables 1-3.

### Comparative Examples 1.1-6.1

The preparation methods of the lithium-ion battery in Comparative Examples 1.1-6.1 were referred to Examples 1-6, which were different in that only the second monomer was added as the monomer for preparing the polymer in the preparation of the polymer, where a mass of the second monomer was a sum of masses of the first monomer and the second monomer in the corresponding Examples 1-6, and other conditions were consistent with those in the corresponding Examples 1-6.

### Comparative Examples 1.2-6.2

The preparation methods of the lithium-ion battery in Comparative Examples 1.2-6.2 were referred to Examples 1-6, which were different in that in the preparation of the negative electrode plate, steps (1) and (2) were not included, and in step (3), polyethylene oxide was directly added as the polymer, and a mass and a number average molecular weight of the polyethylene oxide were consistent with the corresponding polymers of Examples 1-6.

### Example 7

A preparation method of a lithium-ion battery in this example included the following steps.

### (1) Preparation of a Negative Electrode Plate

S1: 2-isocyanatoethyl acrylate and 2-hydroxy-4-cmethylpyridine were added into 100 g of p-xylene in an inert atmosphere, and stirred at 50° C. for 200 minutes at a rotating speed of 400 r/min, and then the solvents were removed to obtain a first monomer.

S2: 0.6 g of first monomer, 0.4 g of poly(ethylene glycol) methyl ether acrylate, 0.0002 g of AIBN, 90.98 g of lithium carbon, 0.02 g of lithium powder, 4 g of conductive carbon black, and 4 g of PVDF were added into 100 g of p-xylene in an inert atmosphere, and uniformly mixed to obtain a negative electrode active slurry, the negative electrode active slurry was coated on a copper foil, and a polymerization reaction was initiated at 60° C. for 3 hours. After the polymerization, the negative electrode active slurry was dried and cut to obtain the negative electrode plate.

### (2) Preparation of a Positive Electrode Plate

97 g of nickel cobalt manganese ternary material (Li[Ni_{0.6}Co_{0.2}Mn_{0.2}]O₂), 2 g of conductive carbon black, 1 g of polyvinylidene fluoride (dissolved in 100 g of NMP) and 50 g of NMP were evenly mixed and coated on a surface of an aluminum foil current collector, followed by drying, rolling and cutting, to obtain the positive electrode plate.

### (3) Assembly

The positive electrode plate, a separator and the negative electrode plate obtained above were laminated to obtain a lithium-ion battery cell, injected with an electrolyte solution (SEVEN CZWL21), packaged and formed to obtain the lithium-ion battery.

### Example 8

A preparation method of a lithium-ion battery in this example included the following steps.

### (1) Preparation of a Negative Electrode Plate

S1: isocyanatoethyl methacrylate and N-(4-pyridinemethyl)ethylamine were added into 100 g of p-xylene in an inert atmosphere, and stirred at 50° C. for 200 minutes at a rotating speed of 400 r/min, and then the solvents were removed to obtain a first monomer.

S2: the first monomer, acrylic acid and AIBN initiator were mixed in an inert atmosphere, and a polymerization reaction was initiated at 60° C. for 3 hours to obtain a polymer.

S3: 1 g of polymer, 90.98 g of lithium carbon, 0.02 g of lithium powder, 4 g of conductive carbon black and 4 g of PVDF were added into 100 g of water in an inert atmosphere, stirred at 500 r/min for 6 hours, and then evenly mixed to obtain a negative electrode active slurry, the negative electrode active slurry was coated on a copper foil, dried and cut to obtain a negative electrode active layer.

S4: a lithium foil with a thickness of 5 microns commercially purchased from China Energy Lithium Co., Ltd. was rolled on the negative electrode active layer, and cut to obtain the negative electrode plate, where a mass of the lithium foil was 0.02 g.

### (2) Preparation of a Positive Electrode Plate

97 g of nickel cobalt manganese ternary material (Li[Ni_{0.6}Co_{0.2}Mn_{0.2}]O₂), 2 g of conductive carbon black, 1 g of polyvinylidene fluoride (dissolved in 100 g of NMP) and 50 g of NMP were evenly mixed and coated on a surface of an aluminum foil current collector, followed by drying, rolling and cutting, to obtain the positive electrode plate.

### (3) Assembly

The positive electrode plate, a separator and the negative electrode plate obtained above were laminated to obtain a lithium-ion battery cell, injected with an electrolyte solution (SEVEN CZWL21), packaged and formed to obtain the lithium-ion battery.

### Example 9

This example was basically the same as Example 1, except that the mass ratio of the lithium powder to the polymer was 0.05:0.9. The negative electrode active layer included 0.9 g of polymer, 90 g of lithium carbon, 0.05 g of lithium powder, 4.525 g of conductive carbon black and 4.525 g of PVDF.

The raw materials used in the preparation of the first monomers, the polymers and the negative electrode active layers in Examples 1-6 are listed in Table 1-1 and Table 1-2.

The preparation conditions of the first monomers and the polymers in Examples 1-6 are listed in Table 2.

The structural formulae of the first monomers in Examples 1-6 are listed in Table 3.

The characterization information of the polymers in Examples 1-8 is listed in Table 4.

TABLE 1-1

| | Raw material for preparing first monomer | | | Second monomer | Initiator |
|---|---|---|---|---|---|
| Example 1 | isocyanatoethylacrylate | 2-hydroxy-4- | — | Poly(ethylene | Azobisiso- |
| | | cmethylpyridine | | glycol) methyl | butyronitrile |
| | | | | ether acrylate | |
| Example 2 | isocyanatoethylmethacrylate | 2-hydroxy-4- | — | Acrylic acid | Benzoyl |
| | | cmethylpyridine | | | peroxide |
| Example 3 | D-2-amino-4-bromopentenoic | 4-trifluoromethyl | — | Poly(ethylene | Benzoyl |
| | acid | thiophenyl | | glycol) acrylate | peroxide |
| | | isocyanate | | | |
| Example 4 | isocyanatoethyl methacrylate | N-(4- | — | Poly(ethylene | Azobisiso- |
| | | pyridinemethyl) | | glycol) | heptanenitrile |
| | | ethylamine | | acrylate | |
| Example 5 | isocyanatoethylacrylate | N-(4- | — | Acrylic acid | Benzoyl |
| | | pyridinemethyl) | | | peroxide |
| | | ethylamine | | | |
| Example 6 | isocyanatoethylmethacrylate | 2,4- | N-(4- | Methyl | Tert-Butyl |
| | | dichloroaniline | pyridinemethyl) | methacrylate | peroxybenzoate |
| | | | ethylamine | | |

TABLE 1-2

| | | | | Conductively | |
|---|---|---|---|---|---|
| | Negative electrode active material | Lithium powder | Polymer | carbon black | PVDF |
| | and mass/g | mass/g | mass/g | mass/g | mass/g |
| Example 1 | Lithium carbon/90.98 | 0.02 | 1 | 4 | 4 |
| Example 2 | Hard carbon/95 | 0.02 | 0.5 | 2.24 | 2.24 |
| Example 3 | Tin metal/90 | 0.01 | 1.5 | 4.245 | 4.245 |
| Example 4 | Lithium carbon/45 | 0.02 | 2.0 | 1.49 | 1.49 |
| | Hard carbon/50 | | | | |
| Example 5 | Hard carbon/75 | 0.02 | 3.0 | 2.99 | 2.99 |
| | Tin metal/16 | | | | |
| Example 6 | Lithium carbon/35 | 0.01 | 5.0 | 2.495 | 2.495 |
| | Hard carbon/55 | | | | |

TABLE 2

| | | | | Preparation condition of | |
|---|---|---|---|---|---|
| | Preparation condition of first monomer | | | polymer | |
| | Stirring | Stirring | Reaction | Polymerization | Polymerization |
| | time/min | speed/(r/min) | temperature/° C. | temperature/° C. | time/h |
| Example 1 | 200 | 400 | 50 | 80 | 3 |
| Example 2 | 50 | 800 | 90 | 70 | 5 |
| Example 3 | 260 | 200 | 50 | 65 | 4 |
| Example 4 | 150 | 600 | 95 | 55 | 5 |
| Example 5 | 160 | 500 | 80 | 45 | 6 |
| Example 6 | 200 | 280 | 100 | 80 | 2 |

TABLE 3

| | |
|---|---|
| 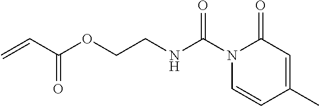 [SMILES: C=CC(=O)OCCNC(=O)n1ccc(C)cc1=O] | Example 1 |
| 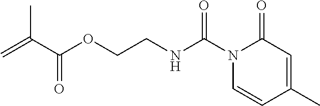 [SMILES: C=C(C)C(=O)OCCNC(=O)n1ccc(C)cc1=O] | Example 2 |
| 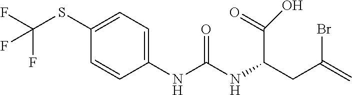 [SMILES: C=C(Br)C[C@H](NC(=O)Nc1ccc(SC(F)(F)F)cc1)C(=O)O] | Example 3 |
| 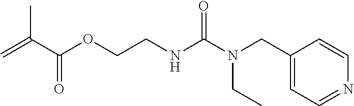 [SMILES: C=C(C)C(=O)OCCNC(=O)N(CC)Cc1ccncc1] | Example 4 |
| 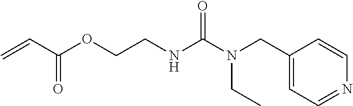 [SMILES: C=CC(=O)OCCNC(=O)N(CC)Cc1ccncc1] | Example 5 |
| 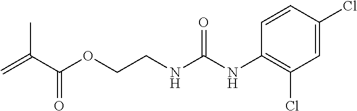 [SMILES: C=C(C)C(=O)OCCNC(=O)Nc1ccc(Cl)cc1Cl] | Example 6 |
| 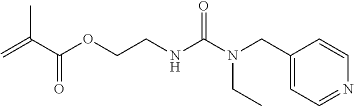 [SMILES: C=C(C)C(=O)OCCNC(=O)N(CC)Cc1ccncc1] | |

TABLE 4

| | Mass proportion | Number average | Degree of |
|---|---|---|---|
| | of first | molecular weight of | crystallinity |
| | structural unit/% | polymer | of polymer/% |
| Example 1 | 40 | 90,000 | 35 |
| Example 2 | 60 | 56,000 | 32 |
| Example 3 | 80 | 10,000 | 26 |
| Example 4 | 30 | 12,000 | 15 |
| Example 5 | 90 | 41,000 | 30 |
| Example 6 | 95 | 35,000 | 12 |
| Example 7 | 40 | 90,000 | 35 |
| Example 8 | 40 | 90,000 | 35 |

The related characterization methods of the polymers in Table 4 were as follows:

Number average molecular weight test of a polymer: the polymer was dissolved in a tetrahydrofuran solvent to form a uniform liquid system, subjected to suction filtration through an organic film, samples were taken and detected in a Japan Shimadzu GPC-20A gel chromatograph to collect molecular weight information.

Test of degree of crystallinity of a polymer: the polymer was ground into powder, and the degree of crystallinity of the polymer was tested by Shimadzu XRD-7000 X-ray diffractometer with θ/θ scanning mode, and the sample was placed horizontally to test the degree of crystallinity of the polymer. The degree of crystallinity of the polymer was based on the fact that an X-ray scattering intensity is in direct proportion to a mass of a scattering substance, crystalline scattering was separated from amorphous scattering on a diffraction diagram, and the degree of crystallinity Xc=A/(A+B), where A was a crystalline scattering intensity and B was an amorphous scattering intensity.

In particular, for the performance test of the polymer in Example 7, the method included treating the negative electrode plate in tetrahydrofuran at 60-100° C. for 10-60 hours to obtain a supernatant after suction filtration, and then performing column chromatography separation on the supernatant to obtain a polymer, and then performing the above tests of the number average molecular weight and the degree of crystallinity.

### Experimental Example

The lithium-ion batteries of the above examples and comparative examples were tested for the initial charge/discharge efficiency and cycling performance. The test results are shown in Table 5, and the test methods are as follows.

1. Initial charge/discharge efficiency: a battery charging-discharging tester was used to charge an unformed lithium-ion battery to 4.25 Vat 25° C. with a constant current of 0.1 C, and then charge the battery at a constant voltage until the current dropped to 0.02 C. After standing for 5 minutes, the battery was discharged to 2.5 V with a constant current of 0.1 C. A first charge capacity Q-charge and a first discharge capacity Q-discharge of the battery were recorded, and a initial charge/discharge efficiency of the battery was calculated, where η=E-discharge/E-charge×100%.

2. Cycling performance: a lithium-ion battery was tested at 25° C. with a battery charge-discharge tester for charging and discharging cycle. A charging and discharging system was as follows: charging the battery to 4.25 V with a constant current of 1 C, and then charging the battery with a constant voltage until the current dropped to 0.02 C. After standing for 5 minutes, the battery was discharged to 2.5 V with a constant current of 1 C, and this was one cycle. A cycle number of the battery charging-discharging tester was set to 5,000 times. With the cycle of the battery, the battery capacity decayed continuously, and the cycle number experienced when the capacity decayed to 80% of the first discharge capacity Q-discharge was recorded as the cycle life of the battery.

TABLE 5

| | Initial charge/ | |
|---|---|---|
| | discharge | Cycling |
| | efficiency/% | performance/times |
| Example 1 | 92.03 | 1425 |
| Comparative Example 1.1 | 88.34 | 852 |
| Comparative Example 1.2 | 87.45 | 743 |
| Example 2 | 91.33 | 1052 |
| Comparative Example 2.1 | 87.53 | 737 |
| Comparative Example 2.2 | 86.65 | 572 |
| Example 3 | 91.13 | 1183 |
| Comparative Example 3.1 | 88.02 | 842 |
| Comparative Example 3.2 | 87.12 | 627 |
| Example 4 | 91.63 | 1073 |
| Comparative Example 4.1 | 88.01 | 838 |
| Comparative Example 4.2 | 86.72 | 637 |
| Example 5 | 93.06 | 1053 |
| Comparative Example 5.1 | 89.51 | 731 |
| Comparative Example 5.2 | 87.82 | 652 |
| Example 6 | 91.83 | 1211 |
| Comparative Example 6.1 | 87.53 | 772 |
| Comparative Example 6.2 | 86.42 | 678 |
| Example 7 | 92.31 | 1532 |
| Example 8 | 91.73 | 1372 |
| Example 9 | 91.42 | 1274 |

As can be seen from the data in Table 5, the lithium-ion battery prepared with the negative electrode plate of the present disclosure has higher initial charge/discharge efficiency and better cycling performance.

The implementations of the present disclosure are described above. However, the present disclosure is not limited to the foregoing implementations. Any modification, equivalent substitution and improvement made without departing from the spirit and principle of the present disclosure shall fall within the protection scope of the present disclosure.

What is claimed is:

1. A negative electrode plate, comprising a current collector, a negative electrode active layer arranged on at least one functional surface of the current collector, and a lithium source; and
the negative electrode active layer comprises a negative electrode active material and a polymer, the polymer comprises a first structural unit, the first structural unit is selected from an olefin compound containing a substituted or unsubstituted ureido group, and the olefin compound containing the substituted or unsubstituted ureido group comprises at least one cyclic group.

2. The negative electrode plate according to claim 1, wherein the olefin compound containing the substituted or unsubstituted ureido group has a structure shown in Formula 1: [symbol]
Formula 1
wherein R₁, R₃ and R₄ are each independently selected from H, halogen, nitro, cyano, substituted or unsubstituted C₁₋₁₂ alkyl, substituted or unsubstituted C₁₋₁₂ alkoxy, and substituted or unsubstituted amino; R₂ is selected from carbonyl, substituted or unsubstituted (hetero)aryl, ester, substituted or unsubstituted C₁₋₁₂ alkylene, carboxyl, or a chemical bond; M₁ is selected from H, carbonyl, substituted or unsubstituted C₁₋₂₀ alkyl, substituted or unsubstituted C₁₋₂₀ alkoxy, hydroxyl, halogen, amino, nitro, trifluoromethyl, sulfenyl, and substituted or unsubstituted (hetero)aryl; M₂ and M₃ are each independently selected from hydrogen, substituted or unsubstituted C₄₋₆₀ (hetero)aryl, substituted or unsubstituted C₁₋₂₀ alkyl, substituted or unsubstituted C₁₋₂₀ alkoxy, carbonyl, substituted or unsubstituted C₂₋₁₂ cycloalkyl containing heterocyclic atom, acyl, carboxyl, ester, or M₂ and M₃ bond to form a ring; and R₁-R₄ and M₁-M₃ comprise at least one cyclic group.

3. The negative electrode plate according to claim 2, wherein, when R₁, R₃ and R₄ have a substituent, the substituent is selected from halogen, nitro, cyano, hydroxyl, trifluoromethyl, and C₁₋₁₂ sulfenyl.

4. The negative electrode plate according to claim 1, wherein a molecular weight of the olefin compound containing the substituted or unsubstituted ureido group ranges from 100 to 5,000.

5. The negative electrode plate according to claim 1, wherein the molecular weight of the olefin compound containing the substituted or unsubstituted ureido group ranges from 300 to 1,500.

6. The negative electrode plate according to claim 1, wherein the lithium source is distributed on a surface and/or in an interior of the negative electrode active layer.

7. The negative electrode plate according to claim 1, wherein the lithium source is selected from a lithium powder or a lithium foil.

8. The negative electrode plate according to claim 1, wherein the negative electrode active material comprises hard carbon, a tin-based material and a lithium carbon material.

9. The negative electrode plate according to claim 1, wherein a number-average molecular weight of the polymer ranges from 4,000 to 90,000.

10. The negative electrode plate according to claim 1, wherein a mass proportion of the first structural unit in the polymer is no less than 30%.

11. The negative electrode plate according to claim 1, wherein a degree of crystallinity of the polymer is less than or equal to 35%.

12. The negative electrode plate according to claim 1, wherein the olefin compound containing the substituted or unsubstituted ureido group is prepared by a method comprising the following process of:
reacting a solvent system containing a first isocyanate compound and a first amine compound or a solvent system containing a second isocyanate compound and a second amine compound to obtain the olefin compound containing the substituted or unsubstituted ureido group, wherein the first isocyanate compound meets a structure shown in Formula 2a, the first amine compound meets a structure shown in Formula 3a, and the first amine compound is a primary amine or secondary amine compound; and the second amine compound meets a structure shown in Formula 2b, the second isocyanate compound meets a structure shown in Formula 3b, and in Formula 3b, Mₓ is M₂ or M₃, [symbol]
Formula 2a Formula 3a; [symbol]
Formula 2b Formula 3b;

13. The negative electrode plate according to claim 12, wherein the first isocyanate compound meeting Formula 2a is selected from at least one of propenyl isocyanate, acrylic isocyanate, and acryloyl isocyanate, or derivatives thereof; and/or
the first amine compound meeting Formula 3a is selected from at least one of 2-aminopyrimidine-5-carboxylic acid, 2-amino-3-iodo-5-methylpyridine, N-(4-pyridinemethyl)ethylamine, 3 -methylthiophene-2-carboxamide, 2-bromo-3-amino-4-methylpyridine, 6-azauracil, 3-chloro-4-fluorobenzylamine, 2-amino-5,7-difluorobenzothiazole, 3,4-pyridinediimide, morpholine, 2,4-dichloroaniline, 3-aminophthalic anhydride, 2-amino-3-hydroxymethylpyridine, 3-amino-4-chloropyridine, triphenylmethylamine, 1,3-benzothiazole-5-amine, 2-amino-5-cyanopyridine, 4-aminoisoxazole, 2-amino-isonicotinic acid ethyl ester, 2,2′-dipicolylamine, 1,2-dimethyl piperazine, L-prolinamide, propylthiouracil, 5-fluoro-2-(3H)-benzothiazolone, 5-bromopyrimidine-4-one, N-acetyl-D-alanine, (S)-4-isopropyl-2-oxazolidinone, 1-(2-piperazine-1-ylacetyl)pyrrolidine, 2-methyl-4-acetylaminopyridine, 2-chloromethyl-6-methyl-thieno[2,3-D]pyrimidine-4-(3H)-one, 2-hydroxy-4-cmethylpyridine, trithiocyanuric acid, 2-methylthio-4,6-dihydroxypyrimidine, 4-hydroxy-6-trifluoromethylpyrimidine, (1,4,7,10-tetraaza-cyclododec-1-yl)-allyl acetate, (S)-(-)-2-amino-4-pentenoic acid, Fmoc-L-allylglycine, Fmoc-D-allylglycine, DL-2-amino-4-pentenoic acid, or D-2-amino-4-bromopentenoic acid.

14. The negative electrode plate according to claim 12, wherein the second amine compound meeting Formula 2b is selected from at least one of a pentenoic acid olefin compound containing a primary amine or secondary amine group, a glycine olefin compound containing a primary amine or secondary amine group, or a carboxylic acid ester olefin compound containing a primary amine or secondary amine group; and/or
the second isocyanate compound meeting Formula 3b is selected from, for example, at least one of p-methoxyphenyl isocyanate, 3,4-dichlorophenyl isocyanate, 4-methoxybenzyl isocyanate, 2-phenethyl isocyanate, 4-bromo-3-methylphenyl, 2-(methoxycarbonyl)phenyl isocyanate, 4-bromo-2-chlorophenyl isocyanate, 2,3,5-dimethylphenyl isocyanate, 2-methoxy-4-nitrobenzene isocyanate, 4-chloro-3-nitrobenzene isocyanate, 2-chloro-5-(trifluoromethyl)phenyl isocyanate, 2,5-difluorophenyl isocyanate, 4-cyanophenyl isocyanate, 6-fluoro-1H-1,3-benzodioxin(hetero)-8-yl isocyanate, 4-isocyano-3-methyl-5-phenyl isoxazole, α-methylbenzyl isocyanate, 2-methyl-3-nitrophenyl isocyanate, 4-trifluoromethyl thiophenyl isocyanate, 2-nitrophenol isobutyrate, methyl 4-isocyanatobenzoate, benzyl 4-isothiocyantetrahydroxy-1-(2H)-pyridylcarboxylate, 2-thiophene isocyanate, 3-chloro-4-methoxyphenyl isocyanate, 2,3-dihydro-1-benzofuran-5-yl isocyanate, 2-fluoro-4-isocyanate-l-methoxybenzene, methyl 3 -isocyanatothiophene-2-carboxylate, 3-bromophenyl isocyanate, or 4-(methylthio)phenyl isocyanate.

15. The negative electrode plate according to claim 1, wherein the polymer further comprises a second structural unit, the second structural unit is selected from an olefin compound without a substituted or unsubstituted ureido group, and the olefin compound without the substituted or unsubstituted ureido group is selected from at least one of acrylic acid, acrylate, polyethylene glycol methacrylate, methyl methacrylate, acrylonitrile, amino acrylate, trimethylolpropane trimethacrylate, or a vinyl silicon material.

16. The negative electrode plate according to claim 1, wherein the negative electrode active layer comprises 90%-99% of negative electrode active material, 0.001%-1% of polymer, 0.499%-4% of binder, and 0.5%-5% of conductive agent in terms of mass percentage.

17. The negative electrode plate according to claim 1, wherein a mass ratio of the lithium source to the polymer is 1:(1-1,000).

18. The negative electrode plate according to claim 1, wherein a thickness of the current collector ranges from 2 μm to 20 μm.

19. The negative electrode plate according to claim 1, wherein a thickness of the negative electrode active layer ranges from 3 μm to 120 μm.

20. A lithium-ion battery, comprising the negative electrode plate according to claim 1.
